(19) United States
(12) Patent Application Publication
(10) Pub. No.: US 2020/0018281 A1
(43) Pub. Date: Jan. 16, 2020

(54) WAVE ENERGY CONVERTER

(71) Applicant: AMOG Technologies Pty Ltd, Notting Hill, Victoria (AU)

(72) Inventors: Paul SINCOCK, Glen Waverley, Victoria (AU); Adrian Conrad EASSOM, Boronia, Victoria (AU); Stuart John WALES, Kew, Victoria (AU); Hayden MARCOLLO, Box Hill North, Victoria (AU)

(21) Appl. No.: 16/335,494

(22) PCT Filed: Sep. 25, 2017
(86) PCT No.: PCT/AU2017/051043

§ 371 Date: Mar. 21, 2019

(30) Foreign Application Priority Data
Sep. 23, 2016 (AU) 2016903861
Oct. 21, 2016 (AU) 2016904281

(51) Int. Cl. F03B 13/20

(52) U.S. Cl. CPC F03B 13/20; F05B 2240/93; F05B 2220/7068

(57) ABSTRACT

A wave energy converter is disclosed, comprising: a body configured to float in water and roll and/or pitch in response to wave action; a pendulum supported by the body and configured to swing in response to rolling and/or pitching of the body; an energy converting means associated with the pendulum and configured to convert swinging of the pendulum relative to the body into electrical energy; a pendulum adjusting means configured to adjust a swinging period of the pendulum, wherein the pendulum adjusting means includes one or more flywheels, each of the one or more flywheels being selectively operably connectable to the pendulum; a body tuning means configured to adjustably tune rolling characteristics of the body; and a controller configured to control the body tuning means such that a rolling period of the body approximates or matches a wave energy peak period.

### FIELD OF THE INVENTION

The present invention relates to apparatus that convert energy provided by waves in a body of water into electrical energy.

### BACKGROUND OF THE INVENTION

Wave power is a form of renewable energy that is a desirable alternative to non-renewable energy sources, such as oil and coal. Apparatus that harness the energy of waves may be known as wave energy converters (WECs). The current technology for wave energy conversion is in its infancy, and therefore, a wide variety of WECs having vastly different designs have been proposed.

A WEC is designed to convert the mechanical energy of waves in a body of water, such as the ocean, into electrical energy. There are obvious benefits to utilising wave motion for energy generation, for example, the abundance of ocean waves, the low (if any) emissions in energy generation, and low environmental impact.

One attempt to harness wave energy is disclosed in US patent publication no. 2015/0054285. This patent publication describes various embodiments of a WEC having a pendulum that is swingable in a body subject to wave action. The pendulum includes a pendulum adjuster configured to adjust a centre of gravity of the pendulum such that the pendulum oscillates at or near the frequency of the waves. In at least one embodiment, the pendulum is connected, via a rotating shaft, to a wheel which drives a pair of electrical generators. A disadvantage to this design is the requirement of a separate mechanical system (i.e., separate to the pendulum) to convert the energy of the waves into electrical energy. U.S. Pat. Nos. 8,102,065 and 8,836,152 disclose similar WECs.

An object of the present invention is to provide a WEC that may overcome certain deficiences or disadvantages of prior WECs, or is at least a useful alternative.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In an aspect, the present invention provides a wave energy converter, comprising:

a body configured to float in water and roll and/or pitch in response to wave action;

a pendulum supported by the body and configured to swing in response to rolling and/or pitching of the body;

an energy converting means associated with the pendulum and configured to convert swinging of the pendulum relative to the body into electrical energy;

a pendulum adjusting means configured to adjust a swinging period of the pendulum, wherein the pendulum adjusting means includes one or more flywheels, each of the one or more flywheels being selectively operably connectable to the pendulum;

a body tuning means configured to adjustably tune rolling characteristics of the body; and

a controller configured to control the body tuning means such that a rolling period of the body approximates or matches a wave energy peak period.

The pendulum is preferably supported by the body on a rotatable shaft that is configured to rotate due to the swinging of the pendulum. Each of the one or more flywheels are selectively operably connectable to the rotatable shaft to adjust a moment of inertia of the rotatable shaft to thereby adjustably tune the swinging period of the pendulum (or the natural frequency of the pendulum).

The energy converting means or energy converter preferably includes one or more permanent magnets associated with the pendulum and a stator in the form of one or more coils associated with the body. The one or more permanent magnets are preferably arranged at or near a distal end of the pendulum (i.e., an end opposite a pivot about which the pendulum is swingably supported on the rotatable shaft). The one or more coils are preferably arranged on the body about a swing path of the pendulum such that an electromotive force (EMF) is induced in the one or more coils due to their interaction with a moving magnetic field of the one or more permanent magnets.

In one embodiment, the pivot is preferably a universal joint such that the pendulum is swingable in any direction with respect to the rotatable shaft. In this embodiment, the one or more coils are preferably arranged on the body in an inverted semi-hemisphere such that the one or more coils are at a same radial distance away from the pivot. In an alternative embodiment, the pendulum may be constrained to swing in a single plane. In this embodiment, the one or more coils may be arranged on the body in an arcuate track such that the one or more coils are at a same radial distance away from the pivot, or the one or more coils may be arranged in arcuate tracks arranged both above and below a swing path of the one or more permanent magnets of the pendulum. In any of these embodiments, the one or more coils may be aligned such that a plane of the coil windings is generally perpendicular to the swing path of the pendulum. Sets of one or more magnets may be arranged on the pendulum offset horizontally with respect to adjacent sets of one or more magnets. Similarly, sets of one or more coils may be arranged on the body offset horizontally with respect to adjacent sets of one or more coils. In a further alternative embodiment, the one or more coils may be associated with the pendulum and the one or more permanent magnets may be associated with the body.

The rate at which energy is converted from mechanical energy to electrical energy in the wave energy converter may be varied by controlling an amplitude of swinging of the pendulum. Accordingly, the energy converting means preferably also includes a variable damping means or a variable damper for damping the swinging of the pendulum. The variable damping means is configured to vary an electrical inductance and/or resistance of a circuit comprising the one or more coils to thereby dampen the swinging of the pendulum. The variable damping means may include a switch to vary the number of the one or more coils connected to the circuit. The controller preferably controls the variable damping means and the switch to vary current induced in the one or more coils which thereby adjustably dampens the swinging of the pendulum.

The energy converting means may also include a conditioning means or conditioner for rectifying the electrical energy. The energy converting means may also include a transforming means or transformer for transforming the electrical energy. The electrical energy may be transferred from the energy converting means, via one or more power cables, to a power substation located at shore. The one or more power cables may be connected to the body via an articulatable connection configured to decouple relative motion between the body (due to the wave action) and the one or more power cables. The articulatable connection may comprise the connection/interface disclosed in U.S. Pat. No. 6,848,862 or US patent publication no. 2012/0247809, the entire contents of each of these publications is hereby incorporated by reference.

The body preferably comprises a hull configured to float in water. In one embodiment, the hull may be axissymmetric about a vertical axis such that its roll and/or pitch response to the wave action is insensitive to a direction of incoming wave action. Additionally, the hull may be longer in one primary axis or direction (e.g., longitudinal) as compared to another axis or direction (e.g., beam). In another embodiment, the hull may be asymmetric about an axis.

The hull may be moored when in the water via a spread mooring system or a single point mooring system. The spread mooring system preferably comprises at least two mooring lines releasably connected at opposite longitudinal ends of the hull. More preferably, at least two mooring lines are releasably connected at each longitudinal end of the hull. The mooring lines may be connected to the hull via a mooring arm arranged at each longitudinal end of the hull. Each mooring arm preferably releasably receives at least two mooring lines, each of the at least two mooring lines being preferably rotatably connected to the mooring arm. Each mooring arm is preferably arranged on the hull at or near the water line and at or near a longitudinal centreline of the hull.

If the spread mooring system is used with a hull having an asymmetric shape, the asymmetric hull is preferably adjustably aligned so that it faces beam with respect to the incoming wave action as the direction of the wave action changes.

The body tuning means or body tuner preferably comprises two or more discrete chambers in the hull configured to receive ballast, preferably liquid ballast in the form of water. The body tuning means is configured to move the liquid ballast between the two or more chambers to adjust a centre of gravity of the body and/or a metacentric height of the body to thereby adjustably tune the rolling characteristics of the body. The two or more chambers may each include one or more partitions to reduce sloshing of the liquid ballast. As is stated above, the controller is configured to control the body tuning means such that the rolling period of the body approximates or matches a wave energy peak period. Advantageously, the wave energy peak period corresponds to a wave period having the highest energy.

The pendulum adjusting means or pendulum adjuster may also be configured to adjust a centre of gravity of the pendulum to thereby adjust the swinging period of the pendulum. The pendulum adjusting means preferably includes a mass in the form of a bob that is selectively movable along a shaft of the pendulum to adjust the centre of gravity of the pendulm and thereby its swinging period. The controller preferably controls the pendulum adjusting means such that the swinging period of the pendulum is a ratio of the rolling period of the body. In a preferred embodiment, this ratio is in the range of 0.8 to 1.2. Advantageously, the pendulum acts as a tuned mass damper/dynamic vibration absorber to minimise motion of the body.

The wave energy converter also preferably includes a wave measurement device communicatively coupled to the controller and configured to measure the wave energy peak period. The controller preferably receives, from the wave measurement device, wave energy peak period information and then: (1) controls the body tuning means to adjustably tune the rolling period of the body so that it approximates or matches the received wave energy peak period; (2) calculates an optimal swinging period of the pendulum and an optimal damping value of the variable damping means, said optimal swinging period and optimal damping value corresponding to a theoretical maximum power output of the wave energy converter; (3) controls the pendulum adjusting means to adjustably tune the swinging period of the pendulum to match the calculated optimal swinging period; and (4) controls the variable damping means to adjustably tune the damping of the pendulum to match the calculated optimal damping value.

Advantageously therefore, according to the invention, the rolling period of the body, the swinging period of the pendulum, and the amplitude of swinging of the pendulum are all tuneable so as to convert as much energy as possible from the wave action into electrical energy. Further advantageously, a separate mechanical system (i.e., separate to the pendulum) is not required to convert the energy of the waves into electrical energy.

The energy converting means may also include a power take-off (PTO) device. The PTO device may be associated with, or connected to, the rotatable shaft of the swingable pendulum. As the rotatable shaft rotates, the PTO device may be configured to drive, optionally via a gearbox, an electric motor, generator, or alternator (3 phase, AC, or DC) to generate additional electrical energy from the swinging of the pendulum. Advantageously, the generator (or electric motor or alternator) may also be utilised to adjust the swinging period of the pendulum (as an alternative to the one or more flywheels or the selectively movable mass of the pendulum adjusting means). In the process of producing the additional electrical energy, the electric generator provides a torque resistance. If the electric generator includes a means to adjust the torque resistance, then, through the active control of this torque resistance, the overall system dynamics can be affected. Devices such as variable flux electric generators and mechanically actuated variable flux generators, can achieve this. One such way is by sliding magnets in and out of proximity with the electric coils of the electric generator. By alternating or varying the torque (or torque resistance) throughout one cycle of a pendulum swing on the wave energy converter, the dynamic stiffness of the system may be altered. Thereby, by adjusting the torque resistance of the electric generator connected to the rotatable shaft of the swingable pendulum, the swinging period of the pendulum (or a natural frequency of the pendulum) can be adjusted and hence the system tuned to match different desired natural frequencies.

The one or more flywheels of the pendulum adjusting means may be selectively connected to the rotatable shaft on a low-speed side of the gearbox. Alternatively, the one or more flywheels may be selectively connected between the gearbox and generator/alternator (i.e. on a high-speed side of the gearbox). In an embodiment comprising more than one flywheel, each flywheel may be selectively connected to the rotatable shaft or the high-speed side of the gearbox independently of any other flywheel to adjust the system dynamic inertia and therefore fine tune the swinging period of the pendulum.

The abovedescribed wave measurement device may also measure other wave information, such as wave height information and wave direction information, and may communicate this other wave information to the controller. The wave energy converter may also include one or more other sensor devices configured to measure other environmental characteristics, such as wind information, and may communicate this other environmental information to the controller. The controller may then utliise the other wave information and/or the other environmental information to control one or more of the energy converting means, the body tuning means, and the pendulum adjusting means to optimise the performance of the wave energy converter.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a front (partially) cross-sectional view of a wave energy converter according to an embodiment of the invention;

FIG. 2A is a side perspective view of a hull of the wave energy converter of FIG. 1;

FIG. 2B is a front view of the hull of FIG. 2A;

FIG. 3 is a plot of the operating efficiency of the wave energy converter of FIGS. 1 and 2;

FIG. 4 is a plot of the power output of the wave energy converter of FIGS. 1 and 2;

FIG. 5 is similar to FIG. 2B, but further illustrates an articulatable power cable associated with the wave energy converter of FIG. 1;

FIG. 6 is a top-down view of a mooring system for mooring the wave energy converter of FIG. 1; and

FIG. 7 is a side view of various components of the wave energy converter of FIG. 1.

### DETAILED DESCRIPTION OF AN EMBODIMENT

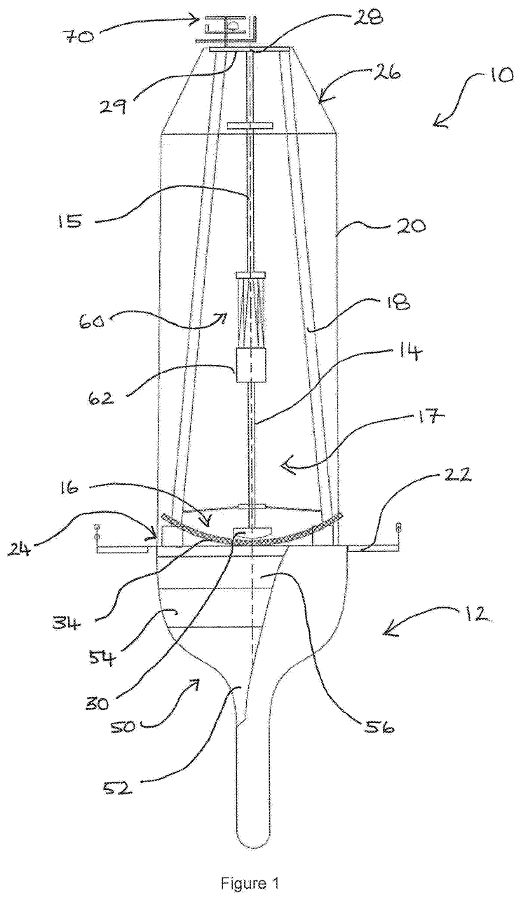

Referring to FIG. 1, there is shown a wave energy converter (WEC) 10 in accordance with an embodiment of the invention. The WEC 10 includes a body in the form of a hull 12 (illustrated partially cut-away) configured to float in water and roll and/or pitch in response to wave action, a pendulum 14 supported by the hull 12 and configured to swing in response to rolling and/or pitching of the hull 12. The WEC 10 includes an energy converting means or energy converter 16 associated with the pendulum 14 and configured to convert swinging of the pendulum 14 relative to the hull 12 into electrical energy for use. The WEC 10 also includes a pendulum adjusting means or pendulum adjuster 90 (FIG. 7) configured to adjust a swinging period of the pendulum. The pendulum adjusting means 90 includes one or more flywheels 92 that are each selectively operably connectable to the pendulum 14. The WEC 10 also includes a body tuning means or body tuner 50 configured to adjustably tune rolling characteristics of the hull 12 (or WEC 10) when in the water. The WEC 10 also includes a controller [not shown] configured to control or tune various features of the WEC 10, as is described later. Advantageously, according to the invention, the controller is able to adjustably tune rolling characteristics of the hull 12 when in water, such that a rolling period of the hull 12 approximates or matches a wave energy peak period, as is described later.

The pendulum 14 is supported by the hull 12 on a rotatable shaft 29 mounted upon a rigid upwardly extending support structure 18. The rotatable shaft 29 is configured to rotate due to the swinging of the pendulum 14. The support structure 18 is located within a housing 20 on an upper deck surface 22 of the hull 12. The support structure 18 is mounted upon, or integral with, the upper deck surface 22 at a lower end 24 of the support structure 18. The pendulum 14 is pivotally mounted to the support structure 18, via the rotatable shaft 29, at an opposite upper end 26. The pendulum 14 pivots about a pivot 28 centrally located along the length of the rotatable shaft 29. In the illustrated embodiment, the pivot 28 comprises a universal joint such that the pendulum 14 is swingable in any direction about the pivot 28. In an alternative non-illustrated embodiment, the pivot 28 may be configured such that the pendulum 14 is constrained to swing in a single plane only. Advantageously, the pendulum 14 acts as a mass damper/dynamic vibration absorber to minimise motion of the hull 12.

The energy converting means 16 includes a permanent magnet 30 arranged at a distal end 17 of the pendulum 14 (i.e., the end opposite the pivot 28), and one or more stator coils [not shown] arranged under an inverted semi-hemispherical dish-like surface 34 located upon the upper deck surface 22 of the hull 12 about (or under) a swing path of the pendulum 14. The one or more stator coils are arranged under the inverted semi-hemispherical dish 34 such that each coil is at a same radial distance away from the pivot 28 of the pendulum 14. Furthermore, each coil is oriented such that a plane correponding to the coil windings of each coil is generally perpendicular to the swing path of the pendulum 14. Advantageously, the one or more stator coils are located about the swing path of the pendulum 14 such that an electromotive force (EMF) is induced in the one or more stator coils due to their interaction with a moving magnetic field of the permanent magnet 30.

The rate at which energy is converted from mechanical energy to electrical energy in the WEC 10 may be varied by controlling an amplitude of swinging of the pendulum 14 as detailed in US patent publication no. 2015/0054285, the entire contents of which is hereby incorporated by reference. Accordingly, the energy converting means 16 also includes a variable damping means or a variable damper [not shown] for damping the swinging of the pendulum 14. The variable damping means is configured to vary an electrical inductance and/or resistance of a circuit [not shown] comprising the one or more stator coils to thereby dampen the swinging of the pendulum. The variable damping means may include a switch [not shown] to vary the number of the one or more stator coils connected to the circuit.

As is described above, the WEC 10 also includes a controller. The controller controls the variable damping means and the switch to vary current induced in the one or more stator coils which thereby adjustably dampens the swinging of the pendulum 14.

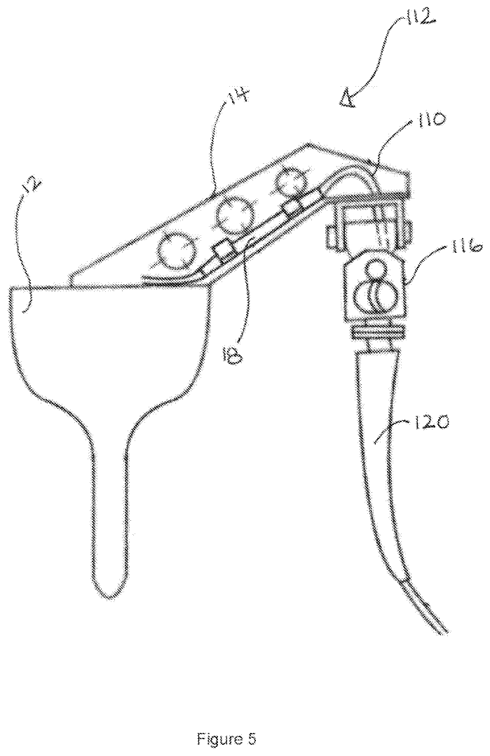

The energy converting means 16 also includes a conditioning means or conditioner [not shown] for rectifying the electrical energy generated by the WEC 10. The energy converting means 16 also includes a transforming means or transformer [not shown] for transforming the electrical energy generated by the WEC 10. The generated electrical energy may be transferred from the energy converting means 16, via a power cable 110 (FIG. 5), to a power substation located at shore [not shown]. The power cable 110 is connected to the hull 12 via an articulatable connection 112 configured to decouple relative motion between the hull 12 (due to wave action) and the power cable 110. Advantageously, the articulatable connection 112 limits the effect that the rolling/pitching of the hull 12 has on the mechanical strength and reliability of the power cable 110. The articulatable connection comprises a connector arm 114 connected at a first end to the hull 12, and a a gimbal 116 connected to the connector arm 114 at a second opposite end. The gimbal 116 is configured to provide a rotatable connection such that the movement of the hull 12 is decoupled from, or not transferred to, the power cable 110. The connector arm 114 and gimbal 116 include internal conduits 118 for the routing of the power cable 110. A bend restrictor 120 is located at a remote end of the gimbal 116 (i.e. remote from the connector arm 114) to restrict or limit bending of the cable 110.

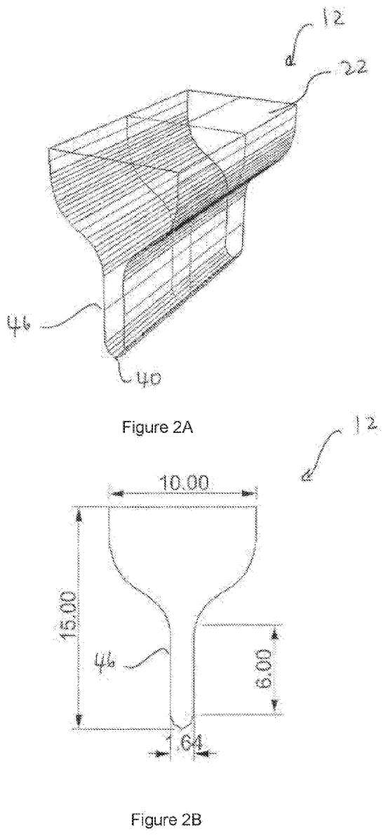

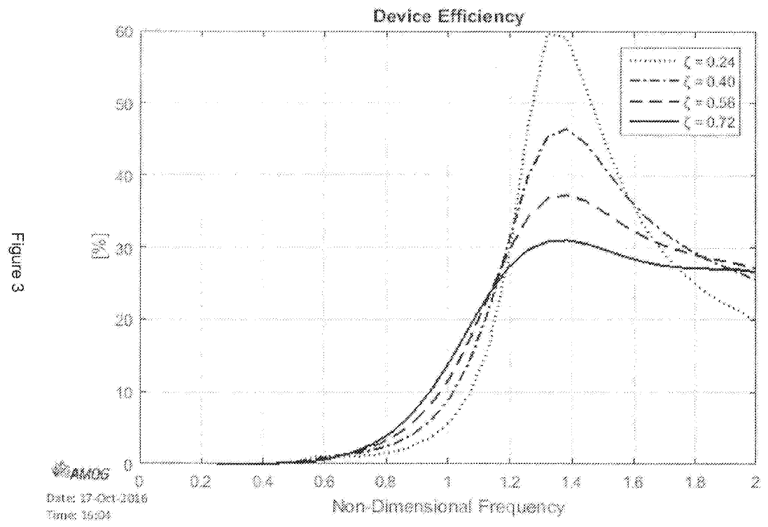

Referring now to FIGS. 2A and 2B, the hull 12 comprises a generally inverted “tear-drop” shape (when viewed in side cross-section). The hull 12 is illustrated in FIGS. 2A and 2B without the housing 20 for the sake of clarity. The hull 12 is symmetic about a vertical plane extending between the deck surface 22 and a rounded keel 40, and running the entire longer length of the hull. The hull has an approximate mass of 900 tonnes and may comprise steel. Advantageously, the illustrated hull 12 is configured such that its roll and/or pitch response to wave action is insensitive to a direction of the incoming wave action, however this is only practical when the hull is generally axissymmetic about the vertical axis through the centre. The hull 12 has a beam width of approximately 10 metres, a height of approximately 15 metres extending between the deck surface 22 and the keel 40, and a length of approximately 25 metres extending from the bow 42 to the stern 44. The keel 40 has a width of approximately 1.64 metres. The “tear-drop” shaped hull 12 comprises a first, lower, portion 46 having a parallel hull sides and a length of approximately 6 metres. These dimensions are merely exemplary. Other suitable dimensions or other suitable hull shape forms, such as semi-hexagonal designs, may be utilised with the wave energy converter of the present disclosure. The tear-drop shape may also be free flooding so as to minimise buoyancy and improve stability of the hull whilst maximising the hydrodynamic benefit by attracting a larger wave force.

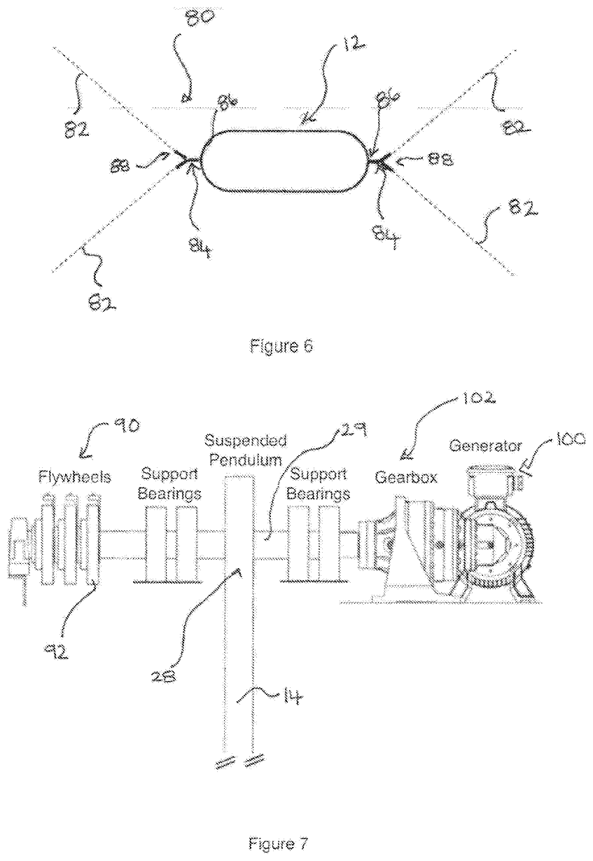

Referring to FIG. 6, the hull 12 may be moored when in the water via a spread mooring system. The spread mooring system 80 comprises two mooring lines 82 releasably connected at each longitudinal end 13 of the hull 12 via a mooring arm 84. Each mooring arm 84 is generally Y-shaped when viewed top-down. The mooring arm 84 is connected at a first end 86 to the hull 12. Each mooring line 82 is rotatably connected to the mooring arm 84 at a second opposite end 88. Each mooring arm 84 is connected to the hull 12 at or near the water line and at or near a longitudinal centreline of the hull 12.

The body tuning means 50 comprises three discrete chambers 52, 54, 56 located one above the other in the hull 12, each chamber being configured to receive ballast. The lowermost ballast chamber 52 includes a solid ballast material, and the middle and upper ballast chambers 54, 56 respectively include liquid ballast. The solid ballast material is preferably concrete and has an approximate mass of 265 tonnes. The liquid ballast is preferably water and also an approximate mass of 265 tonnes.

The body tuning means 50 is configured to move the liquid ballast between the middle and upper ballast chambers 54, 56 to adjust a centre of gravity of the WEC 10 and/or a metacentric height of the WEC 10 to thereby adjustably tune the rolling characteristics of the hull 12 (or WEC 10). The middle and upper ballast chambers 54, 56 also include one or more partitions or baffles [not shown] to reduce sloshing of the liquid ballast. Advantageously, according to the invention, the controller is configured to control the body tuning means 50 such that the rolling period of the hull 12 approximates or matches a wave energy peak period, typically in the range of 8 seconds to 12 seconds. Advantageously, the wave energy peak period corresponds to a wave period having the highest energy.

The pendulum adjusting means 60 (FIG. 1) may also be configured to adjust a centre of gravity of the pendulum 14 to thereby adjust the swinging period of the pendulum 14 (as an alternative to, or in addition to, utilising the flywheels 92). The pendulum adjusting means 60 includes a mass in the form of a bob 62 that is selectively movable along a shaft 15 of the pendulum 14 to adjust the centre of gravity of the pendulum 14 and thereby its swinging period. The controller controls the bob 62 and moves the bob 62 along the shaft 15 such that the swinging period of the pendulum 14 is a ratio of the rolling period of the hull 12. In a preferred embodiment, this ratio is in the range of 0.8 to 1.2. For the illustrated WEC 10, the mass of the bob 62 is 30 tonnes. As is known to those skilled in the art, as the bob 62 is moved toward the distal end 17 of the pendulum 14 (i.e., further away from the pivot 28), the swinging period of the pendulum 14 increases (for a given rolling period of the hull 12 and bob mass 62). As the bob 62 is moved along the shaft 15 toward the pivot 28, the swinging period of the pendulum 14 decreases (for a given rolling period of the hull 12 and bob mass 62).

Referring to FIG. 7, the energy converting means 16 also includes a power take-off device (PTO) associated with, or connected to, the rotatable shaft 29 of the swingable pendulum 14. As the rotatable shaft 29 rotates (due to the swinging of the pendulum 14), the PTO device drives an electric generator 100 via a gearbox 102 to generate additional electrical energy (i.e. additional to the energy created by the interaction between the magnets 30 and the stator coils). The additional electrical energy may be transferred to the power substation via the one or more power cables. Advantageously, the generator 100 includes a means [not shown] to adjust a torque resistance of the generator. As is described earlier, through the active control of the torque resistance, the swinging period of the pendulum (or the natural frequency of the pendulum) may be tuned (as an alternative to, or in addition to, utilising the flywheels 92 or the selectively moveable bob mass 62).

As is described earlier, the pendulum adjusting means 90 includes one or more flywheels 92 that are each selectively operably connectable to the rotatable shaft 29 of pendulum 14. In the embodiment illustrated in FIG. 7, three flywheels 94 are operably connected to the rotatable shaft 29 to adjust a moment of inertia of the rotatable shaft 29 to thereby adjustably tune the swinging period of the pendulum 14. Each of the flywheels 94 are selectively connectable to the rotatable shaft independently of each other fine tune the swinging period of the pendulum 14.

As is detailed above, the WEC 10 of the present invention includes three alternative means for adjusting or fine tuning the swinging period of the pendulm (or the natural frequency of the pendulum). Specifically, these are the selectively operably connectable flywheels 92, the selectively moveable bob 62, and the means to adjust the torque resistance of the generator 100. In an embodiment, the WEC 10 may be configured such that only one of the abovementioned means for adjusting the swinging period of the pendulum is utilised at a given time. However, in an alternative embodiment, a combination of more than one of the abovementioned means for adjusting the swinging period of the pendulum may be utliised at a given time.

The WEC 10 also includes a wave measurement device 70 (FIG. 1) located at an upper end of the housing 20. In an non-illustrated alternative arrangement, the wave measurement device may be located in a separate moored buoy and may be communicatively coupled to the controller by any suitable means known to those skilled in the art, e.g. by RF transmission. The wave measurement device 70 of FIG. 1 is communicatively coupled to the controller and configured to measure a spectral wave height of the incoming wave action and the wave energy peak period of the incoming wave action. The controller receives, from the wave measurement device 70, the spectral wave height and wave energy peak period information, and then:
1. controls the body tuning means 50 to adjustably tune the rolling period of the hull 12 (or WEC 10) so that it approximates or matches the received wave energy peak period (as is described above);
2. calculates an optimal swinging period of the pendulum 14 and an optimal damping value for the variable damping means, said optimal swinging period and optimal damping value corresponding to a theoretical maximum power output of the WEC 10 (as is described later);
3. controls the pendulum adjusting means 60 to adjustably tune the swinging period of the pendulum 14 to match the calculated optimal swinging period; and
4. controls the variable damping means to adjustably tune the damping of the pendulum to match the calculated optimal damping value.

Advantageously therefore, according to the invention, the rolling period of the hull 12 (or WEC 10), the swinging period of the pendulum 14, and the amplitude of swinging of the pendulum 14 are all tuneable so as to convert as much energy as possible from the wave action into electrical energy.

It has been discovered that the most efficient/optimal damping value of the variable damping means corresponds to the minimum damping possible whilst not exceeding the practical amplitude of swinging limit of the pendulum 14. Further, referring to FIG. 3, the peak operating efficiency of the WEC 10 occurs at a non-dimensional frequency ratio of 1.3 (greater than 1.0). The operating efficiency is the ratio of power predicted to be extracted by the pendulum 14 divided by incident wave energy power. The “Non-Dimensional Frequency” axis in FIG. 3 was normalised such that a wave period of 8 seconds was set to a value 1.0.

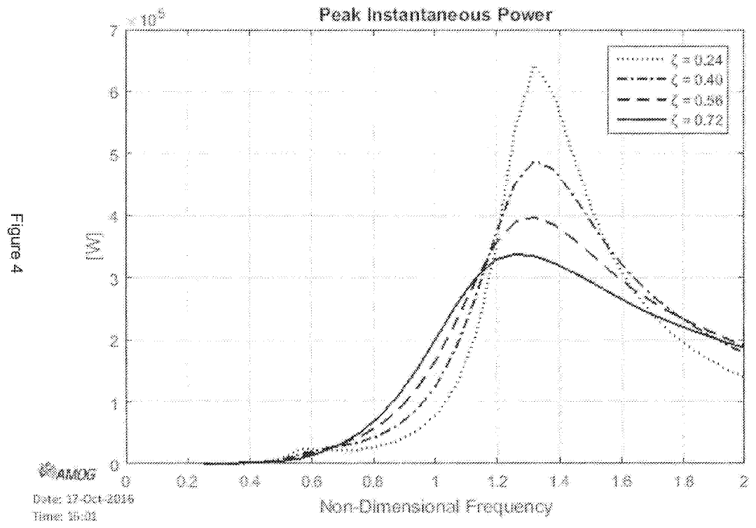

Referring now to FIG. 4, there is shown typical power values produced by the WEC 10 corresponding to the operating efficiencies shown in FIG. 3. The peak instantaneous power in FIG. 4 is the time average power per wave cycle. A peak power is shown to be approximately 640 kW corresponding to 1 m wave height conditions along a 25m wavefront with a linear damping ratio value of zeta=0.24.

Various features of the WEC 10 of the present invention are preferably designed/selected in accordance with certain characteristsics of the wave environment in which the WEC 10 is intended to be operated. The following is a step-by-step process that may be utliised to maximise or optimise the energy output of the WEC 10:
1. determine site specific wave environmental conditions, such as spectral wave heights and wave energy peak periods;
2. select a bob mass 62 based upon limiting the amplitude of swinging of the pendulum 14 to an acceptable value for the hull 12 (a relatively lighter bob mass 62 results in a larger amplitude of swinging as compared to a heavier bob mass 62, yet a lighter bob mass 62 results in greater energy/power output);
3. calculate an inertia ratio, μ, corresponding to the ratio of the pendulum 14 inertia to the hull 12 rolling interia;
4. calculate a pendulum 14 frequency ratio equal to 1/(1+μ);
5. for each sea state, calculate pendulum 14 centre of gravity (length) ranges based upon wave excitation frequency ratios and spectral wave input energies (which is a function of spectral seas and hull 12 wave response characteristics);
6. calculate a damping value of the pendulum 14 based upon maximiming the energy/power output of the WEC 10, and not necessarily based upon minimising the motion of the hull 12 (an ideal damping value will depend upon the spectral wave input energy);
7. check the value of the maximum amplitude of swinging of the pendulum 14 for the hull 12, and reduce bob mass 62 if a maximum ampltiude is exceeded;
8. go back to step 2 and iterate based upon the spectral response to tune the inertia ratio, pendulum frequency ratio, and pendulum damping value (this iteration is required because the hull 12 and pendulum 14 system has a spectral input); and
9. determine the optimal bob mass, pendulum period, and pendulum damping value to maximise energy/power output.

The above listed steps is just one approach for maximising or optimising the energy output of the WEC 10. Other approaches may be known to those skilled in the art.

The present invention provides an economically viable, reliable, and effective WEC. Advantageously, unlike the abovedescribed prior WECs, a separate mechanical system (i.e., separate to the pendulum) is not required to convert the energy of incoming wave action into electrical energy.

It will be understood that the invention disclosed and defined in this specification extends to all alternative combinations of two or more of the individual features mentioned or evident from the text or drawings. All of these different combinations constitute various alternative aspects of the invention.

1-17. (canceled)

18. A wave energy converter comprising:
a body configured to float in water and roll and/or pitch in response to wave action;
a pendulum supported by the body and configured to swing in response to rolling and/or pitching of the body;
an energy converting means associated with the pendulum and configured to convert swinging of the pendulum relative to the body into electrical energy;
a pendulum adjusting means configured to adjust a swinging period of the pendulum, wherein the pendulum adjusting means includes one or more flywheels, each of the one or more flywheels being selectively operably connectable to the pendulum;
a body tuning means configured to adjustably tune rolling characteristics of the body; and
a controller configured to control the body tuning means such that a rolling period of the body approximates or matches a wave energy peak period.

19. The wave energy converter of claim 18, wherein the pendulum is supported by the body on a rotatable shaft configured to rotate due to swinging of the pendulum, and wherein each of the one or more flywheels are selectively operably connectable to the rotatable shaft to adjust a moment of inertia of the rotatable shaft to thereby adjustably tune the swinging period of the pendulum.

20. The wave energy converter of claim 18, wherein the energy converting means includes one or more permanent magnets associated with the pendulum and a stator in the form of one or more coils associated with the body.

21. The wave energy converter of claim 18, wherein the one or more permanent magnets are arranged at or near a distal end of the pendulum, and wherein the one or more coils are arranged about a swing path of the pendulum such that an electromotive force (EMF) is induced in the one or more coils due to their interaction with a moving magnetic field of the one or more permanent magnets.

22. The wave energy converter of claim 21, wherein the pendulum is configured to swing about a pivot, and wherein the one or more coils are arranged on the body in an inverted semi-hemispherical configuration such that the one or more coils are at a same radial distance away from the pivot.

23. The wave energy converter of claim 18, further including a mooring sytem having at least one mooring line connected at opposite longitudinal ends of the body, each mooring line being connected at or near a longitudinal centreline of the body and at or near the water line when the wave energy converter is in water.

24. The wave energy converter of any one of claim 20, wherein the energy converting means further includes a variable damping means controllable by the controller and configured to selectively vary an inductance and/or resistance of a circuit comprising the one or more coils to thereby dampen the swinging of the pendulum.

25. The wave energy converter of claim 18, wherein the pendulum adjusting means further includes a mass that is selectively controllable by the controller to move along a shaft of the pendulum to adjust a centre of gravity of the pendulum to thereby adjust the swinging period of the pendulum.

26. The wave energy converter of claim 18, wherein a ratio of the swinging period of the pendulum to the rolling period of the body is in the range of 0.8 to 1.2.

27. The wave energy converter of claim 26, wherein the body tuning means comprises two or more discrete chambers in the body configured to receive liquid ballast.

28. The wave energy converter of claim 27, wherein the body tuning means is controllable by the controller to selectively move the liquid ballast between the two or more discrete chambers to adjust a centre of gravity of the body and/or a metacentric height of the body to thereby adjustably tune the rolling characteristics of the body.

29. The wave energy converter of claim 18, further including a wave measurement device communicatively coupled to the controller and configured to measure the wave energy peak period.

30. The wave energy converter of claim 29, wherein the controller is configured to receive, from the wave measurement device, wave energy peak period information, and thereafter:
control the body tuning means to adjustably tune the rolling period of the body so that it approximates or matches the received wave energy peak period;
calculate an optimal swinging period of the pendulum and an optimal damping value for the variable damping means, said optimal swinging period and said optimal damping value corresponding to a theoretical maximum power output of the wave energy converter;
control the pendulum adjusting means to adjustably tune the swinging period of the pendulum to match the calculated optimal swinging period; and
control the variable damping means to adjustably tune the damping of the pendulum to match the calculated optimal damping value.

31. The wave energy converter of claim 18, wherein the energy converting means further includes a conditioning means for rectifying the electrical energy.

32. The wave energy converter of claim 18, wherein the energy converting means further includes a transforming means for transforming the electrical energy.

33. The wave energy converter of claim 18, wherein the energy converting means further includes one or more power cables configured to transfer the electrical energy to a power substation remote from the wave energy converter.

34. The wave energy converter of claim 33, wherein the one or more power cables are connected to the body via an articulatable connection configured to decouple relative motion between the body and the one or more power cables.
